(19) United States
(12) Patent Application Publication
(10) Pub. No.: US 2024/0168450 A1
(43) Pub. Date: May 23, 2024

(54) METHOD OF GENERATING MASTER STATE BASED ON GRAPH NEURAL NETWORK FOR REAL-TIME ANOMALY DETECTION

(71) Applicant: UDMTEK, Gyeonggi-do (KR)

(72) Inventors: Gi Nam Wang; Jun Pyo Park; Seung Woo Han; Kang Hee Han; Min Young Jung; Sang Chul Yoo; Geun Ho Yu

(73) Assignee: UDMTEK, Suwon-Si (KR)

(21) Appl. No.: 17/756,460

(22) PCT Filed: Nov. 12, 2021
(86) PCT No.: PCT/KR2021/016481

§ 371 Date: May 25, 2022

(30) Foreign Application Priority Data
Apr. 20, 2021 (KR) 10-2021-0050982

(51) Int. Cl. G05B 19/05; B25J 9/16

(52) U.S. Cl. CPC G05B 19/056; B25J 9/161

(57) ABSTRACT

The present disclosure discloses a method of generating a master state that is a normal state in a repeated cycle by analyzing log data output from a programmable logic controller (PLC). In addition, a method of generating log data as graph data as data preprocessing for generating a master state is disclosed. The method of generating a master pattern and the method of training a cycle analysis model according to the present disclosure are different from the related art in that the methods are a technology of processing a machine control language (low-level language) that is difficult for humans to analyze and converting the machine control language into an analyzable language (high-level language), i.e., a machine language processing (MLP)-based technology that analyzes the executed machine language (a language that controls a machine) with a computer and can be understood by humans.

### TECHNICAL FIELD

The present invention relates to a method of generating a master state of equipment, and more particularly, to a method of finding a major state in a repeated cycle by analyzing log data of equipment.

### BACKGROUND ART

The content described in this section merely provides background information for embodiments disclosed in the present disclosure, and does not constitute the related art.

A programmable logic controller (PLC) is mainly used to build automation lines, and driven by the specification (PLC control logic code) of a PLC control logic written through operation symbols such as AND/OR and relatively simple functions such as TIMER/FUNCTION BLOCK. The control logic is defined using a memory address of PLC hardware. In this case, the memory address of the PLC hardware is called a contact. The automation lines are operated by defining input/output relations to these contacts and controlling values of the contacts for each situation.

In general, a PLC control logic has numerous contacts depending on a scale of the automation lines. Accordingly, attempts to detect anomaly situations in automation lines by analyzing the content of the PLC control logic code between the contacts and analyzing the relations and sequence between the contacts to generate a reference master pattern for determining whether the automation lines are in a normal operating state are being made.

However, the state of automation lines operated by a PLC changes over time due to various causes, such as equipment aging, replacement, and a change in a PLC control code, and the reference master pattern for determining the normal operating state will also change. Accordingly, a previously generated reference master pattern is inappropriate to use as basic data for determining whether the automation lines in a changed environment are in the normal operating state.

In addition, recently in the automated manufacturing industry, as the complexity of the manufacturing lines increases, control logics have become vast and are designed to be very complex. Accordingly, PLC programs are also complicatedly logicalized. For this reason, it is also becoming more and more difficult to diagnose and monitor a PLC program, and accordingly, the time it takes to find and correct an error is gradually increasing.

### RELATED ART DOCUMENT

### Patent Document

(Patent Document 1) Korean Patent No. 10-1527419

### DISCLOSURE

### Technical Problem

The present disclosure is directed to providing a method of generating a master state based on a graph neural network (GNN) by looking at an operating state of equipment and processes as a finite state.

The present disclosure is not limited to the above-described effects, and other objects that are not described may be obviously understood by those skilled in the art from the following description.

### Technical Solution

One aspect of the present invention provides a method of generating graph data for anomaly detection including: (a) dividing each section in which a contact value changes in log data represented by a Gantt chart into one state; (b) identifying a major state in divided states, adding at least one sensor value for each section corresponding to the major state, and converting the log data into a node matrix according to an order of generation of the major state to which the sensor value is added; and (c) converting the log data into edge index data by defining a connection relation between the divided states, representing the divided state as a node, and representing the connection relation of the divided state as an edge.

The operation (a) may include assigning an identification feature for dividing a state according to the changed contact value.

The operation (b) may include counting the number of states having the same identification feature and identifying a state having a number greater than or equal to a preset value as the major state.

The operation (b) may further include assigning an identification code to the identified major state in a One Hot Encoding format.

The operation (b) may include selecting and adding one representative value when there are two or more sensor values output from one sensor in a section.

The connection relation may be a necessary condition or an exclusive condition.

In the operation (c), a node that does not correspond to the major state may be deleted from the node matrix data, and previous and subsequent nodes connected to the deleted node may be connected to convert the log data into data using an edge index.

Another aspect of the present invention provides a method of generating a master state according to the present disclosure for solving the above-described problem which is a method of generating a master state using a plurality of pieces of graph data generated according to the method of generating graph data according to the present disclosure, the method including: (a) inputting one piece of graph data that has not yet been input among the plurality of pieces of graph data to a graph neural network (GNN) AutoEncoder as input data; (b) calculating a difference value (hereinafter “analog level loss”) for a sensor value between reconstruction data output by the GNN AutoEncoder and the input data; (c) calculating an average value of an analog level loss (hereinafter, “node level loss”) for each node, and calculating an average value of the node level loss (hereinafter, “graph level loss”) for each graph; (d) retraining the GNN AutoEncoder using the graph level loss; and (e) repeatedly executing the operations (a) to (d) when there remains graph data that has not yet been input among the plurality of pieces of graph data.

The method may further include, (f) when all of the plurality of pieces of graph data have been input to the GNN AutoEncoder as input data, calculating the average and a standard deviation of the node level loss, and setting a value obtained by adding the standard deviation value reflecting the preset parameter to the average value as a master state upper limit standard.

The method may further include, (f) when all of the plurality of pieces of graph data have been input to the GNN AutoEncoder as input data, calculating the average and a standard deviation of the node level loss, and setting a value obtained by adding the standard deviation value reflecting the preset parameter to the average value as a master state upper limit standard.

The method of generating graph data according to the present disclosure may be implemented by a computer program written to allow a computer to perform each operation of the method of generating graph data and recorded in a computer-readable recording medium.

The method of generating a master state according to the present disclosure may be implemented by a computer program written to allow a computer to perform each operation of the method of generating a master state and recorded in a computer-readable recording medium.

Other specific details of the present invention are included in the detailed description and drawings.

### Advantageous Effects

According to one aspect of the present disclosure, it is possible to generate a master state based on a graph neural network (GNN) from log data and control logic.

According to another aspect of the present disclosure, it is possible to provide various services such as control logic inspection, control logic generation, real-time anomaly detection, reproduction, and productivity and quality analysis by analyzing and graphing a correlation of static and dynamic data flow while a device to be analyzed is controlled and based on an artificial intelligence (AI) model such as a GNN.

The effects of the present invention are not limited to the above-described effects, and other effects that are not described may be obviously understood by those skilled in the art from the following description.

### DESCRIPTION OF DRAWINGS

FIG. 1 is a reference diagram for the overall flow of the invention disclosed in the present disclosure.

FIG. 2 is a schematic flowchart of a method of generating graph data according to the present disclosure.

FIG. 3 is a reference diagram for collection of log data.

FIG. 4 is a reference diagram for state division and state identification features.

FIG. 5 is a reference diagram for identifying a major state.

FIGS. 6 and 7 are reference diagrams for adding sensor values to each section.

FIG. 8 is a reference diagram in which log data is converted into node matrix data.

FIG. 9 is a reference diagram illustrating that a connection relation is defined between adjacent states.

FIG. 10 is a reference diagram for removing a node corresponding to a minor state.

FIG. 11 is a reference diagram for relations between log data, node matrix data, edge index data, and graph data.

FIG. 12 is a reference diagram for a relation between graph data and a cycle.

FIG. 13 is a reference diagram for AutoEncoder.

FIG. 14 is a schematic flowchart of a method of generating a master state according to the present disclosure.

FIG. 15 is a reference diagram for the method of generating a master state according to the present disclosure.

### MODES OF THE INVENTION

Various advantages and features of the present disclosure and methods of accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow a person with ordinary skill in the art (hereinafter, one skilled in the art) to which the present disclosure pertains to completely recognize the scope of the present disclosure, and the scope of the present disclosure will be defined by the scope of the claims.

Terms used in the present disclosure are for explaining embodiments rather than limiting the scope of the present disclosure. Unless otherwise stated, a singular form includes a plural form in the present disclosure. Throughout this specification, the term “comprise” and/or “comprising” will be understood to imply the inclusion of stated constituents but not the exclusion of any other constituents.

Like reference numerals refer to like components throughout the specification and “and/or” includes each of the components described and includes all combinations thereof. Although “first,” “second,” and the like are used to describe various components, it goes without saying that these components are not limited by these terms. These terms are used only to distinguish one component from other components. Therefore, it goes without saying that a first component described below may be a second component within the technical scope of the present disclosure.

Unless defined otherwise, all terms (including technical and scientific terms) used in the present disclosure have the same meanings as commonly understood by those skilled in the art to which the present disclosure pertains. In addition, terms defined in commonly used dictionaries are not ideally or excessively interpreted unless explicitly so defined. Hereinafter, embodiments of the present disclosure will be described in detail with reference to the accompanying drawings.

Definitions of terms used in the present disclosure are as follows.

A master state graphs states of a process and relations between the states, and is a model in which graphed data is indicated by a “standard process graph” such as a “standard state” and a “standard relation” of each phase using a graph neural network (GNN) model.

A programmable logic controller (PLC) is a control device with high autonomy that enables program control by adding a numerical calculation function to a basic sequence control (replacement of functions, such as a relay, a timer, and a counter, with semiconductor devices such as an integrated circuit (IC) and a transistor) function. For reference, in the US Electrical Industrial Standards, a PLC is defined as “an electronic device of digital operation which is used for a programmable memory to perform special functions, such as logic, a sequence, a timer, a counter, and a calculation, through a digital or analog input/output module and controls various types of machines or processors.”

The log data is a result obtained by collecting PLC contact data at regular intervals. According to an operation of equipment on a line, values of contacts on the PLC related to the operation change. Whenever the values of contacts on the PLC change, a log is collected. The log data is data represented as [contact name, value, time] and is value data of a specific contact at a corresponding time.

A cycle is a section in which the contact data is constantly repeated. Units of a cycle may be diverse, such as a plant, a line, a process, etc.

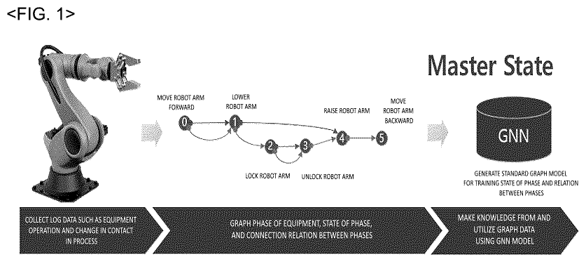

FIG. 1 is a reference diagram for the overall flow of the invention disclosed in the present disclosure.

Referring to FIG. 1, the invention disclosed in the present disclosure may be performed in the order of “method of generating graph data” for first collecting data and pre-processing the collected data, and “method of generating a master state” using the generated graph data. Hereinafter, the “method of generating graph data” and the “method of generating a master state” of the present disclosure will be described in more detail. Each operation of the “method of generating graph data” and the “method of generating a master state” according to the present disclosure may be executed by a processor.

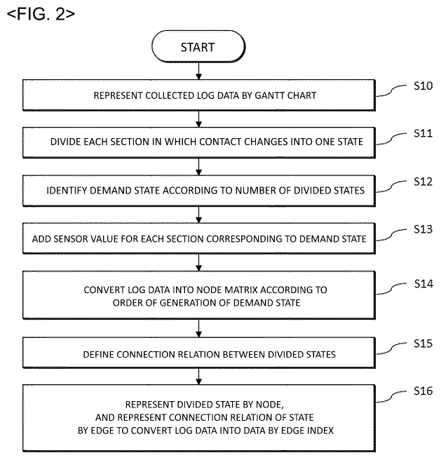

FIG. 2 is a schematic flowchart of the method of generating graph data according to the present disclosure.

First, the log data collected in operation S10 may be represented by a Gantt chart.

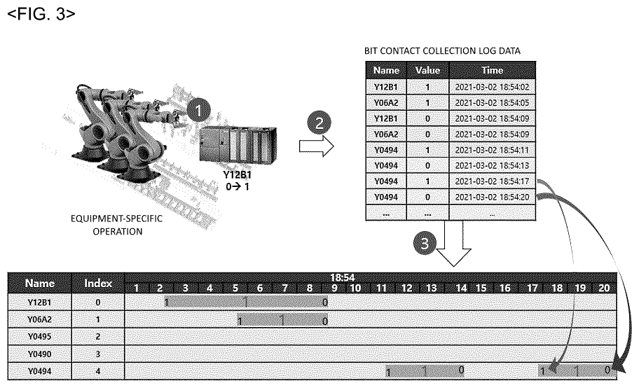

FIG. 3 is a reference diagram for collection of log data.

Referring to FIG. 3, whenever equipment performs a specific operation, a log is generated in the PLC. By collecting the log generated in this way, the data represented in [contact name, value, time], that is, the log data, may be collected. In the example illustrated in FIG. 3, “1” means that the contact changes from an “off” state to an “on” state, and “0” means that the contact changes from the “on” state to the “off” state. The collected log data may be represented by the Gantt chart as illustrated in FIG. 3.

Referring back to FIG. 2, in the next operation S11, in the log data represented by the Gantt chart, each section in which the values of the contacts change may be divided into one state.

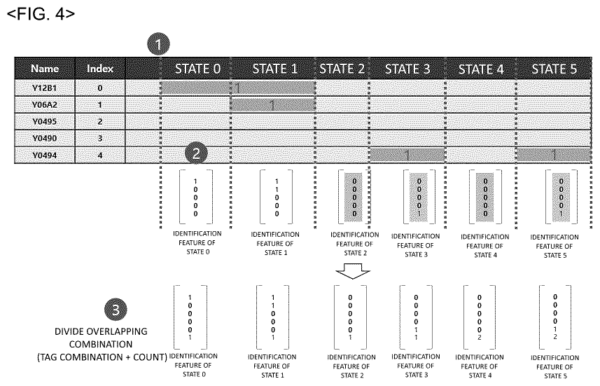

FIG. 4 is a reference diagram for state division and state identification features.

Referring to FIG. 4, it can be seen that a section is divided whenever the change in the contact value occurs (\textcircled{1}). According to the changed values of contacts, an identification feature to divide the state may be given (\textcircled{2}). According to the example illustrated in FIG. 4, the “on” contact is represented by “1” and the “off” contact is represented by “0,” and thus, it can be confirmed that the identification features that “state 0” is [10000], “state 1” is [11000], and “state 2” is are given. Meanwhile, “state 2” and “state 4” have the same identification feature as [00000], and “state 3” and “state 5” have the same identification feature as

In this case, information on the number of overlapping identification features may be added (\textcircled{3}).

Referring back to FIG. 2, in the next operation S12, the number of states having the same identification feature is counted, and a state having a number greater than or equal to a preset value may be identified as a major state.

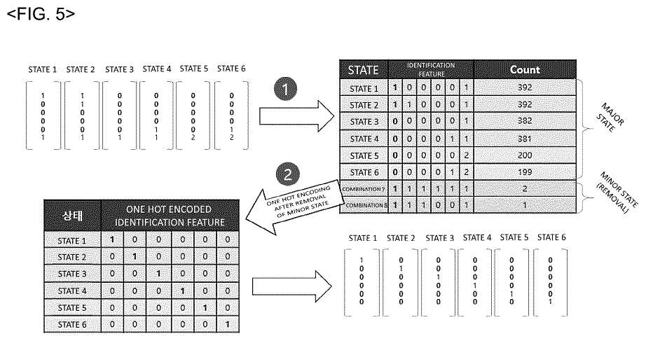

FIG. 5 is a reference diagram for identifying a major state.

Referring to FIG. 5, the number of states with the identification features may be confirmed (\textcircled{1}). According to the number, a frequently occurring state (major) and an infrequently occurring state (minor) may be divided. The frequently occurring state may be identified as the “major state,” and the infrequently occurring state may be deleted. Preferably, the identified major state may give an identification code in the form of One Hot Encoding. Through the One Hot Encoding, the major state may be divided as a single attribute value, and a machine learning process may be more easily performed later.

Referring back to FIG. 2, at least one sensor value may be added to each section corresponding to the major state in operation S13.

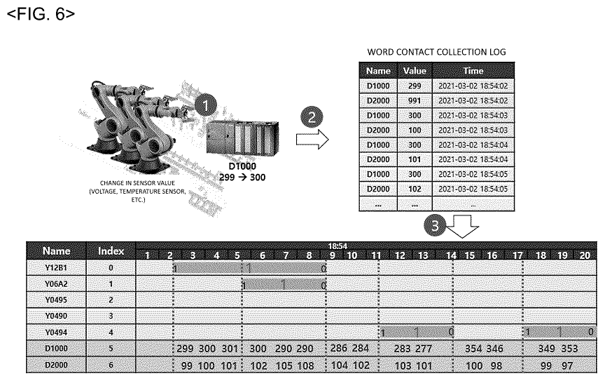

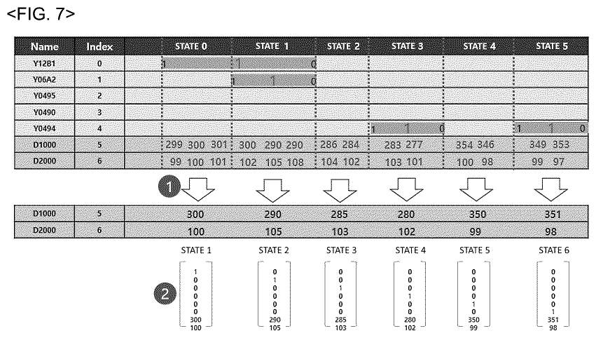

FIGS. 6 and 7 are reference diagrams for adding sensor values to each section.

Referring to FIG. 6, various sensors such as a voltage sensor and a temperature sensor may be attached to equipment, and sensing values may be output from each sensor (\textcircled{1}). The output sensing values may be collected as logs (\textcircled{2}). When a sensing value is represented corresponding to each section according to the output time, the sensing value may be represented as illustrated in FIG. 6 (\textcircled{3}). Although the values output from the two sensors “D1000” and “D2000” are illustrated in FIG. 6, the types and number of sensors may be diverse.

Referring to FIG. 7, two or more sensor values output from one sensor within one section may exist. For example, during the “state 0” section, a “D1000” sensor outputs values “299, 300, 301.” In this case, a representative value (e.g., average value “300”) may be selected (\textcircled{1}) and added to the major “state 1” (\textcircled{2}).

Referring back to FIG. 2, the log data may be converted into node matrix data according to the order of generation of the major state to which the sensor value is added in operation S14.

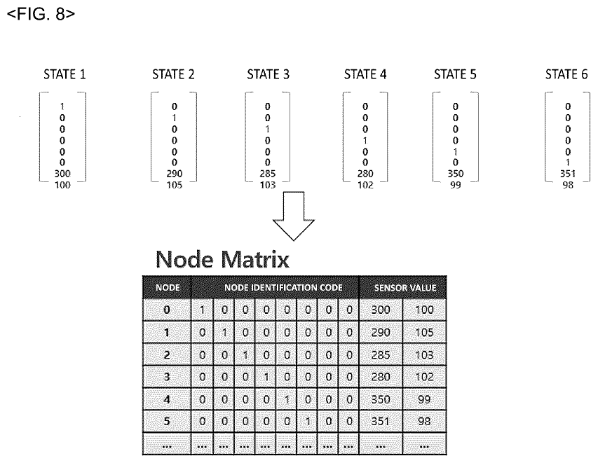

FIG. 8 is a reference diagram in which the log data is converted into the node matrix data.

Referring to FIG. 8, each major state corresponds to one node, and each node corresponds to an identification code. When converted into the node matrix data, the node needs to maintain the order of the log data.

Referring back to FIG. 2, the connection relation between the divided states may be defined in operation S15. The connection relation may be a necessary condition or an exclusive condition.

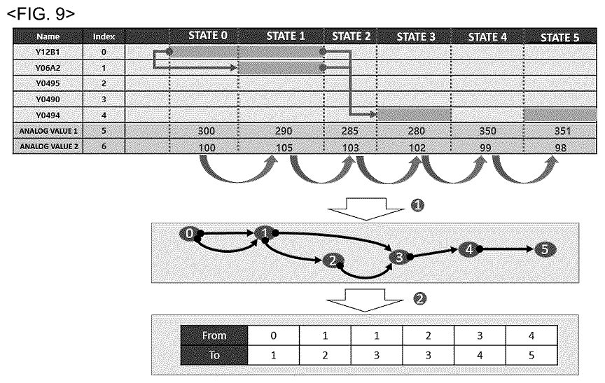

FIG. 9 is a reference diagram illustrating that a connection relation is defined between adjacent states.

Referring to FIG. 9, “Y12B1” is “ON” in state 0, and “Y06A2” is “ON” in state 1. In this case, in order for “Y06A2” to be “ON,” “Y12B1” needs to be “ON,” and “state 0” is a “required condition” relation of “state 1.” In addition, in state 1, “Y12B1” and “Y06A2” need to be “OFF,” and in state 3, “Y0494” is “ON.” In this case, in order for “Y0494” to be “ON,” “Y12B1” and “Y06A2” need to be “OFF,” and “state 1” is an “exclusive condition” relation of “state 3.”

Referring back to FIG. 2, in operation S16, the divided state is represented by a node and the connection relation of the divided state is represented by an edge, and thus the log data may be converted into data using an edge index.

Referring back to FIG. 9, it can be seen that states are represented by edge indexes and graphs connected by edges.

Meanwhile, since the node matrix describes only information on the “major state,” the edge index also leaves only the node for the major state, and it is also necessary to remove the node corresponding to the infrequently occurring state (Minor). According to the embodiment of the present disclosure, a node that does not correspond to the major state may be deleted from the node matrix data, and previous and subsequent nodes connected to the deleted node may be connected to convert the log data into the data using the edge index.

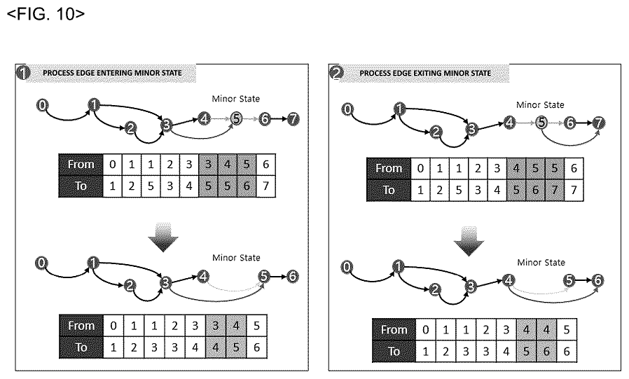

FIG. 10 is a reference diagram for removing a node corresponding to a minor state.

Referring to FIG. 10, node 5, which does not correspond to the major state, needs to be deleted. The example illustrated on the left illustrates the relation that nodes 3 and 4 lead into node 5, and node 6 follows from node 5. Therefore, it is possible to delete node 5 and change nodes 3 and 4 to directly lead into node 6. In this case, node 6 changes to node 5 according to the order of nodes, and node 7 changes to node 6. The example illustrated on the right illustrates that node 4 leads into node 5, and node 5 has a relation of leading into node 6 and node 7. Therefore, it is possible to delete node 5 and change node 4 to lead into node 6 and node 7. In this case, node 6 changes to node 5 according to the order of nodes, and node 7 changes to node 6. Through the above process, the node of the node matrix data and the node of the edge index data may have a mutually corresponding relation.

Through the above process, the log data (Raw Data) is converted into the node matrix data and the edge index data. When the node matrix data and the edge index data are combined, they may be represented by graph data.

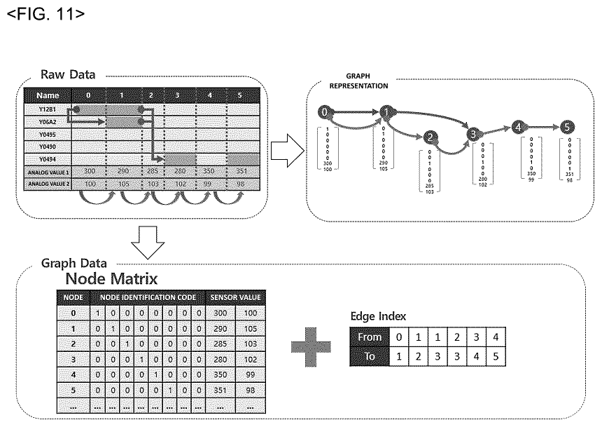

FIG. 11 is a reference diagram for relations between the log data, the node matrix data, the edge index data, and the graph data.

Meanwhile, in a production process, it is common for the same equipment to repeat the same operation. Accordingly, the collected log data (raw data) will also repeat a cycle including similar data, and in this case, one piece of graph data may correspond to one cycle.

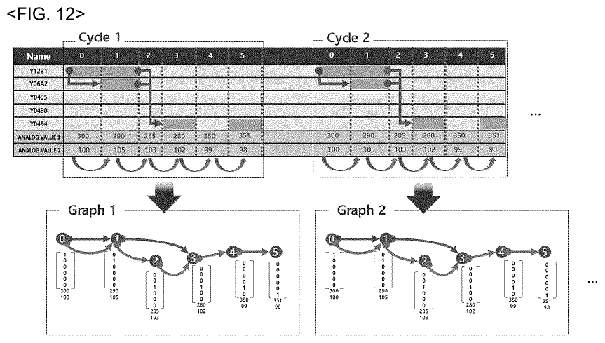

FIG. 12 is a reference diagram for a relation between the graph data and the cycle.

Hereinafter, a master state method will be described using the graph data (node matrix data+edge index data) generated according to the method of generating graph data according to the present disclosure.

Prior to training of the model, the AutoEncoder will be described.

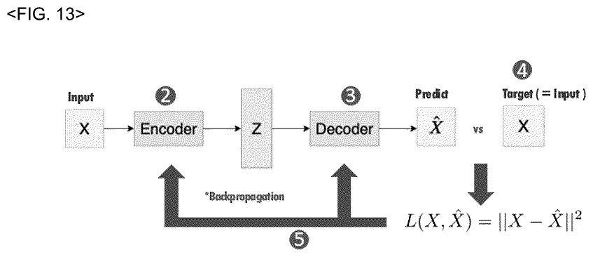

FIG. 13 is a reference diagram for the AutoEncoder.

Referring to FIG. 13, the AutoEncoder may include an encoder and a decoder. The encoder compresses input data (input ‘X’) into low-dimensional embedding Z, and the decoder reconstructs the compressed low-dimensional embedding Z into high-dimensional data \hat{X}. In this case, by comparing a result value (predict) with target data (the same as input data ‘X’), the encoder and decoder are trained in a direction in which a difference value (loss) between the two piece of data is minimized. Therefore, when the AutoEncoder is trained with a large amount of data, a difference value (loss) of data reconstructed for the major state among the input data will be small, and a difference value (loss) of data reconstructed for the minor state (Minor) will be large. It is possible to train a model that detects abnormal data included in a data set by using the difference in the size of the difference value (loss) of the reconstructed data.

In particular, the AutoEncoder can be freely applied by changing a network used for the encoder and decoder according to a type of target data. For image data, a convolution neural network (CNN) is used for the encoder and decoder, and for table data, a multi layered perceptron (MLP) is used for the encoder and decoder. In view of this, the method of generating a master state according to the present disclosure is expanded to the graph data by using the GNN in the encoder and decoder.

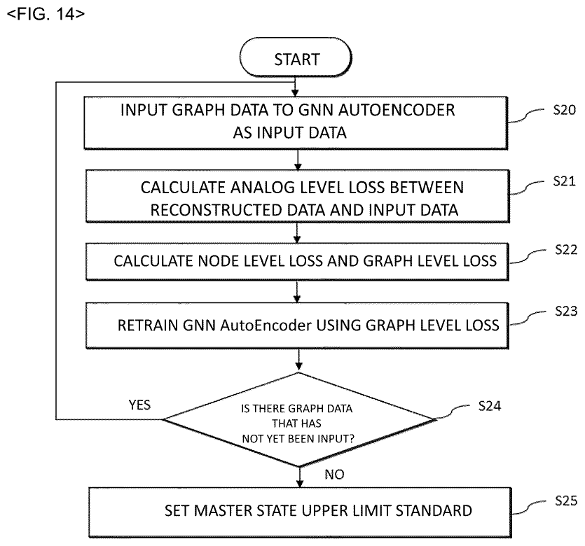

FIG. 14 is a schematic flowchart of the method of generating a master state according to the present disclosure.

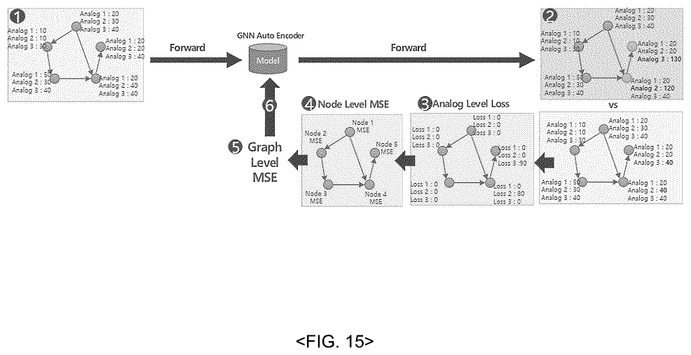

FIG. 15 is a reference diagram for the method of generating a master state according to the present disclosure.

Referring to FIG. 14, in operation S20, one of the plurality of pieces of graph data may be input to the GNN AutoEncoder as the input data (\textcircled{1} in FIG. 15).

In the next operation S21, it is possible to calculate a difference value (hereinafter “analog level loss”) for the sensor value between the reconstructed data (\textcircled{2} in FIG. 15) output by the GNN AutoEncoder and the input data (\textcircled{3} in FIG. 15).

In the next operation S22, the average value (hereinafter referred to as “node level loss”) of the analog level loss may be calculated for each node (\textcircled{4} in FIG. 15), and the average value (hereinafter, “graph level loss”) of the node level loss may be calculated for each graph (\textcircled{5} in FIG. 15).

In the next operation S23, the GNN AutoEncoder may be retrained using the graph level loss (\textcircled{6} in FIG. 15).

In the next operation S24, it may be determined whether there remains graph data that has not yet been input among the plurality of pieces of graph data. When there is graph data that has not been input (YES in S24), the process may proceed to operation S20. In operation S20, operations S20 to S24 may be repeatedly executed while inputting single pieces of graph data that have not yet been input among the plurality of pieces of graph data to the GNN AutoEncoder as the input data.

Meanwhile, when all of the plurality of pieces of graph data have been input to the GNN AutoEncoder, the GNN AutoEncoder is in a trained state. Thereafter, it is possible to determine whether the process is abnormal by using the trained GNN AutoEncoder. However, it is necessary to set a reference range, i.e., an upper limit value, for determining whether there is an abnormality.

According to the embodiment of the present disclosure, when all of the plurality of pieces of graph data have been input to the GNN AutoEncoder as the input data in operation S25, an average μ and a standard deviation σ of the node level loss are calculated, and a value obtained by adding the standard deviation value reflecting the preset parameter to the average value may be set as the master state upper limit standard. For example, when the preset parameter is 1.5, the upper limit value for determining whether the node level loss is abnormal may be “μ+1.5σ.”

According to another embodiment of the present disclosure, when all of the plurality of pieces of graph data have been input to the GNN AutoEncoder as the input data in operation S25, the average and the standard deviation of the graph level loss are calculated, and a value obtained by adding the standard deviation value reflecting the preset parameter to the average value may be set as the master state upper limit standard. For example, when the preset parameter is 1.5, the upper limit value for determining whether the graph level loss is abnormal may be “μ+1.56.”

When data of a new cycle is input, the artificial neural network trained according to the above description is capable of tracking not only whether there is an error in the cycle, but also at which contact or/and link the error occurs. The method of generating a master pattern and the method of training a cycle analysis model according to the present disclosure are different from the related art in that the methods are a technology of processing a machine control language (low-level language) that is difficult for humans to analyze and converting the machine control language into an analyzable language (high-level language), i.e., a machine language processing (MLP)-based technology of analyzing the executed machine language (a language that controls a machine) with a computer that can be understood by humans. By using the cycle analysis model according to the present disclosure, it is possible to provide various services such as control logic inspection, control logic generation, real-time anomaly detection, reproduction, and productivity and quality analysis by analyzing and graphing a correlation of static and dynamic data flow while a device to be analyzed is controlled and based on an artificial intelligence (AI) model such as a GNN.

Meanwhile, the method of generating graph data and method of generating a master state according to the present disclosure may include a processor, an application-specific integrated circuit (ASIC), other chipsets, a logic circuit, a register, a communication modem, a data processing apparatus, and the like known in the art to which the present invention belongs to execute the described calculation and various control logics. In addition, when the above-described control logic is implemented in software, the processor may be implemented as a set of program modules. In this case, the program modules may be stored in the memory device and executed by the processor.

In order for the computer to read the program and execute the methods implemented as a program, the program may include code coded in a computer language such as C/C++, C#, JAVA, Python, machine language, and the like that the processor (CPU) of the computer can read through a device interface of the computer. Such code may include functional code related to functions defining functions necessary for executing the methods, or the like, and include an execution-procedure-related control code necessary for the processor of the computer to execute the functions according to a predetermined procedure. In addition, such code may further include a memory-reference-related code related to a location (address, house number) of the internal or external memory of the computer that should be referenced for additional information or media necessary for the processor of the computer to execute the functions. In addition, when the processor of the computer needs to communicate with any other computers, servers, or the like located remotely in order to execute the above functions, the code may further include a communication-related code for how to communicate with any other computers, servers, or the like located remotely using a communication module of the computer, how to transmit/receive any information or media during communication, or the like.

The storage medium is not a medium that stores data therein for a while, such as a register, a cache, a memory, or the like, but is a medium that semi-permanently stores data therein and is readable by a device. Specifically, examples of the storage medium include, but are not limited to, a ROM, a RAM, a CD-ROM, a magnetic tape, a floppy disk, an optical data storage device, and the like. That is, the program may be stored in various recording media on various servers accessible by the computer or in various recording media on the computer of the user. In addition, the medium may be distributed in a computer system connected by a network, and store computer-readable codes in a distributed manner.

Although exemplary embodiments of the present disclosure have been described with reference to the accompanying drawings, those skilled in the art to which the present disclosure belongs will appreciate that various modifications and alterations may be made without departing from the technical spirit or essential feature of the present invention. Therefore, it is to be understood that the embodiments described hereinabove are illustrative rather than being restrictive in all aspects.

1. A method of generating graph data for anomaly detection, comprising:
(a) dividing each section in which a contact value changes in log data represented by a Gantt chart into one state;
(b) identifying a major state in divided states, adding at least one sensor value for each section corresponding to the major state, and converting the log data into a node matrix according to an order of generation of the major state to which the sensor value is added; and
(c) converting the log data into edge index data by defining a connection relation between the divided states, representing the divided state as a node, and representing the connection relation of the divided state as an edge.

2. The method of claim 1, wherein the operation (a) includes assigning an identification feature for dividing a state according to the changed contact value.

3. The method of claim 2, wherein the operation (b) includes counting the number of states having the same identification feature and identifying a state having a number greater than or equal to a preset value as the major state.

4. The method of claim 3, wherein the operation (b) further includes assigning an identification code to the identified major state in a One Hot Encoding format.

5. The method of claim 1, wherein the operation (b) includes selecting and adding one representative value when there are two or more sensor values output from one sensor in the section.

6. The method of claim 1, wherein the connection relation is a necessary condition or an exclusive condition.

7. The method of claim 1, wherein, in the operation (c), a node that does not correspond to the major state is deleted from the node matrix data, and previous and subsequent nodes connected to the deleted node are connected to convert the log data into data using an edge index.

8. A method of generating a master state using a plurality of pieces of graph data generated through claim 1, the method comprising:
(a) inputting one piece of graph data that has not yet been input among the plurality of pieces of graph data to a graph neural network (GNN) AutoEncoder as input data;
(b) calculating a difference value (hereinafter “analog level loss”) for a sensor value between reconstruction data output by the GNN AutoEncoder and the input data;
(c) calculating an average value of an analog level loss (hereinafter, “node level loss”) for each node, and calculating an average value of the node level loss (hereinafter, “graph level loss”) for each graph;
(d) retraining the GNN AutoEncoder using the graph level loss; and
(e) repeatedly executing the operations (a) to (d) when there remains graph data that has not yet been input among the plurality of pieces of graph data.

9. The method of claim 8, further comprising, (f) when all of the plurality of pieces of graph data have been input to the GNN AutoEncoder as input data, calculating the average and a standard deviation of the node level loss, and setting a value obtained by adding the standard deviation value reflecting the preset parameter to the average value as a master state upper limit standard.

10. The method of claim 8, further comprising, (f) when all of the plurality of pieces of graph data have been input to the GNN AutoEncoder as input data, calculating the average and a standard deviation of the node level loss, and setting a value obtained by adding the standard deviation value reflecting the preset parameter to the average value as a master state upper limit standard.

11. A non-transitory computer-readable medium storing a computer program that allows a computer to perform each operation of the method of generating graph data of claim 1 and recorded in a computer-readable recording medium.

12. A non-transitory computer-readable medium storing a computer program that allows a computer to perform each operation of the method of generating a master state of claim 8 and recorded in a computer-readable recording medium.
